(19) United States
(12) Patent Application Publication
(10) Pub. No.: US 2006/0263745 A1
(43) Pub. Date: Nov. 23, 2006

(54) Periotome

(76) Inventor: Jeffrey Lasner, Purchase, NY (US)

Correspondence Address: ALFRED E. MILLER, 445 W. PUTNAM AVE, GREENWICH, CT, 06830, US

(21) Appl. No.: 11/133,036

(22) Filed: May 20, 2005

(51) Int. Cl. A61C 3/02

(52) U.S. Cl. 433/144

(57) ABSTRACT

A periotome for use in dental extractions and in placing of dental implants. The dental instrument is provided with a thin blade having cutting surfaces that cut the ligaments which bind the tooth to the bone in an up and down sawing motion.

The present invention relates to tooth extractions. Roots of each tooth are encased inn the bone in the mouth. The tooth's hole in the bone is a tooth socket. The tooth is held physically in the socket by means of periodontal ligaments fillers which physically binds the tooth to the bone. In order to extract a tooth from its socket a dentist must espand the tooth from its socket with an instrument and also he or she must separate the ligament or fibrous membrane which connects the tooth to the bone. The surgical procedure is also used in the placing of dental implants.

### BACKGROUND OF THE INVENTION

In the past, the instrument used to perform the above procedure was an elevator which was used to loosen the tooth, widen the space in the bone, and break the ligament which are tiny elastic fibers that attach the tooth to the bone. Once this is accomplished the tooth can be removed from the bone and lifted out of the tooth socket.

Periodontal ligament fibers are progressively severed by means of an elevator. The elevation is wedged between the root and the bone and the fibers are stretched until broken. However, inn the procedure often the surrounding abveolar bone is damaged.

In order to improve on the performance of the elevator and to facilitate minimal damage to the somewhat fragile bone plated adjacent to the tooth socket a thin, hard and strong instrument was developed called a periotome. However, the tooth ligaments have great elastic limits so that the periotome instrument has to lift the fibrous membrane of ligaments out of the tooth socket and stretch the ligaments until they fracture.

### SUMMARY OF THE INVENTION

While the traditional type of periotome described above has facilitated the extraction of teeth, problems have arisen since the instrument must have a thin blade but not sharp in order to enter the periodontal ligament space and operate without tearing adjacent tissue. Due to the limited sharpness of the thin blade of the periotome, an excessive amount of force must be applied to tear the ligaments having great elastic limits frequently causing damage to tissue and bone as well as distinctive bending of the instrument.

In order to overcome the disadvantages of the traditional periotome the present invention has been devised by means of a periotome with micro-serrations so that the ligament bundles are separated into individual ligament fibers that are engaged with a vertical sawing motion instead of stretching the ligaments horizontally.

### DESCRIPTION OF THE DRAWINGS

In order that the invention may be more clearly understood, it will now be disclosed in detail with reference to the accompanying drawings, in which:

FIG. 1 is a perspective view of the improved periotome instrument being handled by a dental professional constructed in accordance with the present invention.

FIG. 2 is a side elevation view of the periotome instrument in its entirety.

FIG. 3 is a front elevation view of the instrument showing the micro-serrations on the blade in greater detail.

FIG. 4 is a side elevation of the instrument.

FIG. 5 is a front elevation view of the instrument being pushed in the sulcus to sever the periodontal ligament from the tooth, and

FIG. 6 is a side elevation view of the periotome instrument being vertically in the sulcus of one of the posterior teeth.

### DESCIPTION OF THE PREFERRED EMBODIMENT

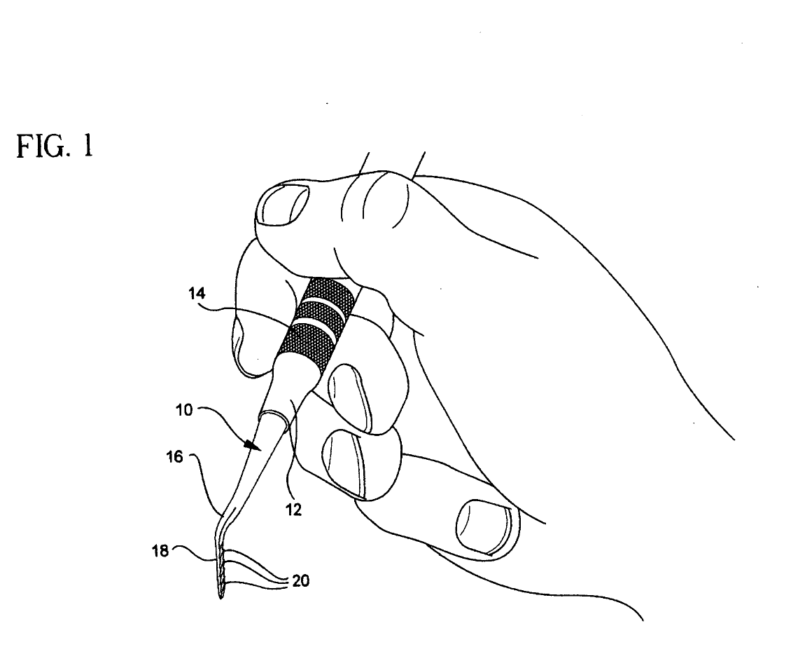

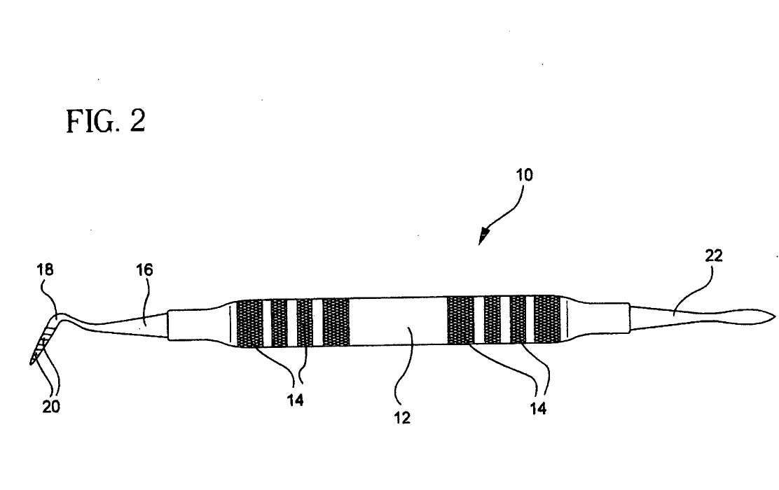

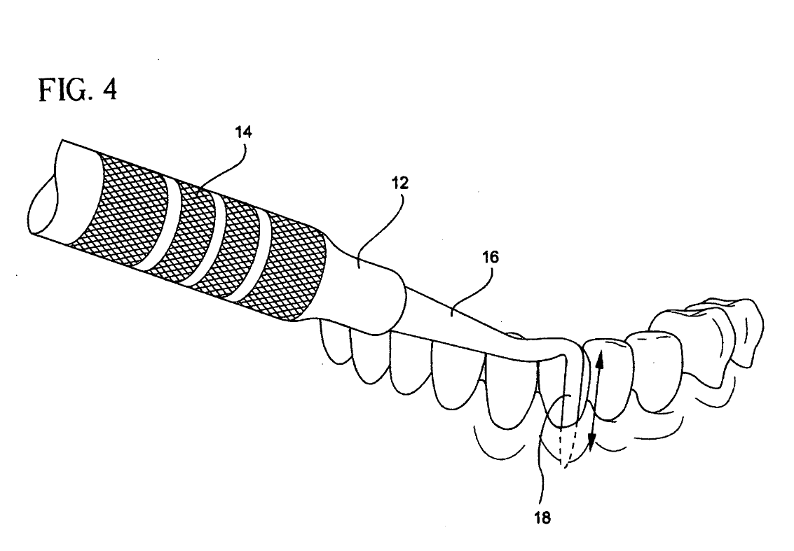

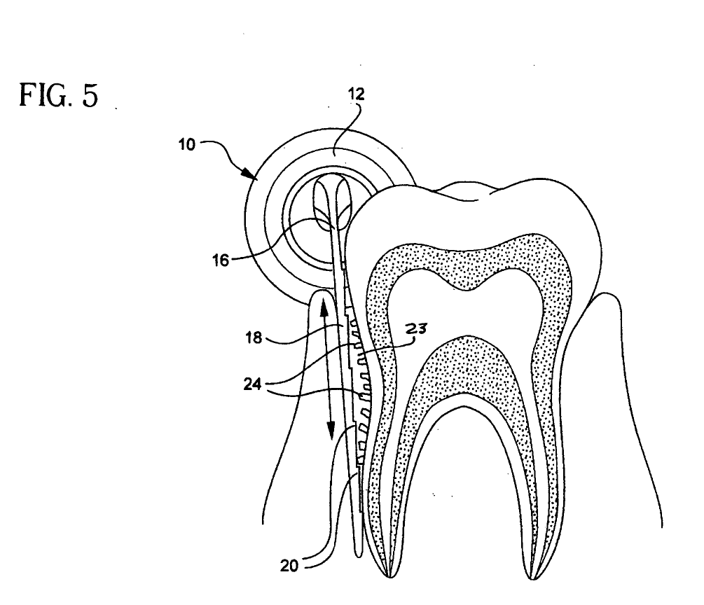

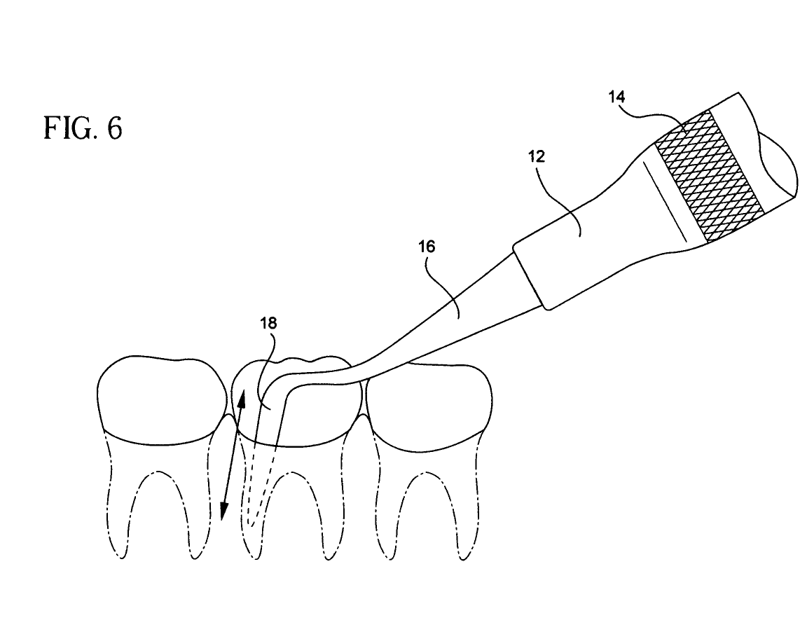

The periotome instrument, as seen in FIG. 1, in the hands of a dental professional and referred to generally by the numeral 10 has a generally cylindrical body or handle 12 having knurled bands 14 for preventing slipping of the instrument in the user's hands. One end of the instrument 16, as seen in FIGS. 1 and 2 is provided with an angled blade 18 offset from the handle 12. The blade is provided with a multiplicity of micro-serrations 20, serving as cutting edges for the instrument. Although the illustrations show micro-serrations on one side of the thin blade 18, preferably fabricated of stainless steel it should be understood that it is within the concept of the invention to provide micro-serrations on both sides of the blade 18. Thus, the blade 18 functions as a saw in an up and down motion, as seen in FIGS. 4, 5 and 6 of the drawings. In this regard, thin but strong blades engage the ligament fibers individually rather than as a bundle to cut more efficiently, thus preparing the tooth for removal more rapidly.

As seen in FIG. 2, the peritome instrument 10 has an offset end 16 and an opposite linear end blade 22, also having micro-serrations 20 (not show). Thus, the angled blade 18 is utilized for the posterior teeth while the straight blade 22 is used when operating on the anterior teeth in the patient's mouth. Thus, it should be apparent that the peritome instrument of the present invention flattens out the fiber strands and saws the strands vertically instead of stretching the strands horizontally until they fracture.

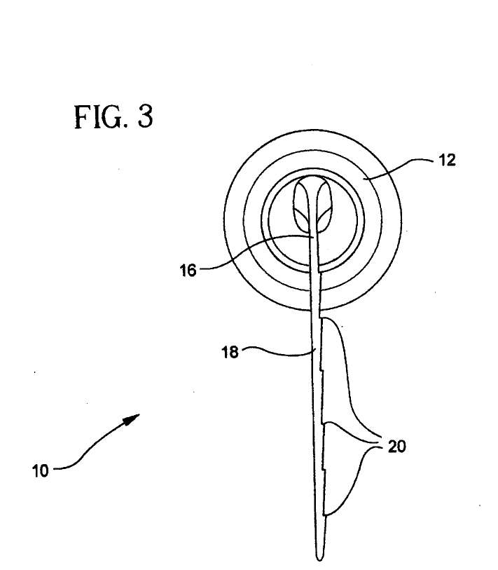

FIG. 3 is a front elevation view of the improved periotome showing the saw-like serrations 20 which cut the elastic-like ligament swithout damaging the adjacent tissue and bone.

As seen in FIGS. 4, 5 and 6 the periotiome blade 18 is inserted in the sulcus 24 and the dental professional with an up and down motion severs circumferentially the periodontal ligament from the tooth so that the tooth can be extracted without the use of excessive force and without damage to the bone.

While there has been shown and described an embodiment of the present invention, it will be understood that one may make various changes in form and details of the device illustrated and its operation without departing from the true spirit and teachings of the invention.

What is claimed is:

1. An improved dental instrument that cuts periodontal ligaments from the root surface of a tooth in a tooth sulcus thus facilitating the removal of a tooth efficiently and with minimal damage to the surrounding tissue and bone comprising: a handle and at least one working end that is angled relative to said handle, said working end being provided with a thin flat blade having a plurality of spaced serrations on one side edge of said flat blade forming cutting surfaces for severing the ligaments circumferentially when said instrument is applied in the sulcus of said tooth socket with an up and down sawing motion.

2. An improved dental instrument as claimed in claim 1 further comprising a second working end that is co-axed with said handle, said working end being a thin, flat blade having spaced serrations.

3. An improved dental instrument as claimed in claim 1 wherein said handle is cylindrical.

4. An improved dental instrument as claimed in claim 3 further comprising at least one knurled band on said cylindrical handle.

5. A method of severing periodontal ligaments from the root surface of the tooth in preparation for tooth removal providing a dental instrument provided with a handle and a working end, said working end having a thin blade provided with serrations on at least one side edge of said blade and moving said blade up and down in the circumferential ligament space between the tooth and surrounding bone thereby cutting said ligaments to facilitate removal of the tooth.

6. The method as claimed in claim 5 wherein said up and down movement is a sawing motion.

7. An improved dental instrument that severs periodontal ligaments from the root surface of a tooth in a tooth socket thus facilitating the removal of the tooth efficiently and with minimum damage to the surrounding tissue and bone comprising: a cylindrical handle, two working ends at opposite ends of said handle, one of said working ends being angled relative to the longitudinal axis of said handle, said one angled working end being provided with a thin flat blade having a plurality of micro-serrations on at least one side of said flat blade forming cutting surfaces to sever the figments circumferentially when said instrument is pushed into the sulcus of said tooth socket with an up and down motion.
